(19) United States
(12) Patent Application Publication
(10) Pub. No.: US 2006/0232837 A1
(43) Pub. Date: Oct. 19, 2006

(54) Reduced error kinematic mount

(76) Inventor: Gad Shelef, Palo Alto, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/110,115

(22) Filed: Apr. 19, 2005

(51) Int. Cl. G03H 1/00

(52) U.S. Cl. 359/1

(57) ABSTRACT

The kinematic mount is used to repeatedly couple two components together. The kinematic mount includes a connector that has a partial spherical surface and a partial cylindrical surface coupled to and substantially opposing the partial spherical surface. The connector includes a bore there-through from the partial spherical surface to the partial cylindrical surface. The bore has a first opening at the spherical surface and a second opening at the cylindrical surface, where a diameter of the first opening is different to a diameter of the second opening to account for loose tolerances of the kinematic mount, such as non coincidental or co-located geometric centers of the partial spherical surface and a partial cylindrical surface or a deviation of a threaded hole in a V-groove formed in a first plate from the center of the V-groove. In some embodiments, the diameter of the first opening is smaller than the diameter of the second opening.

### TECHNICAL FIELD

The present invention relates generally to kinematic mounts that are used for removably coupling two plates to one another, such that despite repeated disassembly and reassembly the plates remain in identical positions when reassembled. In particular, the present invention relates to a kinematic mount that addresses manufacturing imperfections.

### BACKGROUND

Kinematic mounts, otherwise known as kinematic couplings or restraints, are commonly used to couple measuring equipment or instruments to a base or substructure, where despite repeated disassembly and reassembly the plates remain in the same relative position to one another as when initially assembled.

Examples of such instruments include: precision instruments, such as optical elements, including lenses, mirrors, prisms, telescopes, cameras, lasers, sensors, or the like; sensitive measuring equipment; strain sensitive devices; lithography equipment, such as projection optics; and instruments that are disassembled and moved frequently so that a permanent support is not suitable.

Indeed, very small changes in the position of such instruments can make a substantial difference in the accuracy of results obtained from the instrument. Therefore, kinematic mounts were developed to address such precise repeated assembly.

According to well-known principles, for a rigid body to be completely fixed in space, despite repeated disassembly and reassembly, all six degrees of freedom need to be constrained. In other words, three translations and three rotations must be constrained with respect to some arbitrary fixed coordinate system. A mount is said to be kinematic when all six degrees of freedom are constrained without any additional constraints, i.e., any additional constraints would be redundant. A kinematic mount therefore has six independent constraints.

One well-known kinematic mount includes first and second plates. The first plate is generally fixed in space, while the second plate is free to move. The first plate has three V-shaped grooves formed therein, where each groove forms an angle of approximately 120 degrees with each other groove, and the walls of each groove form angles of approximately 45 degrees with the surface of the base plate. The second plate forms three depressions at the apexes of an equilateral triangle. The depressions are aligned with the grooves. During assembly, a spherical member is placed into each groove, contacting the two side walls of each respective groove at two point contacts. The second plate is then positioned onto the spherical members, such that each spherical member rests in a respective depression. In use, instrument may be secured to the second plate, which may be lifted from the first plate and, when replaced, will occupy the identical position relative to the first plate, which normally remains fixed.

However, the above described point contacts between each spherical member and groove leads to concentrated forces at these contact points. These concentrated forces lead to high stresses, known as Hertzian stresses, both at the spherical member and at the groove.

The above described mount, while being sufficient for light loads, such as laboratory applications or light-duty field applications, fails in heavy-duty applications, such as when used in space launch vehicles, where high intensity vibrations and shocks cause failure at the point contacts.

In light of the above it is highly desirable to provide a kinematic mount that addresses the high stresses generated by point contacts, while still providing a kinematic mount, as described above.

Another problem with kinematic mounts is that they often require precise dimensions or strict tolerances to ensure precise alignment on reassembly. Such precise dimensions or strict tolerances are difficult to manufacture and often add significant cost to the manufacturing process. Accordingly, it is highly desirable to provide a kinematic mount that addresses any drawbacks associated with imprecise dimensions or loose tolerances.

### SUMMARY

According to the invention there is provided a kinematic mount for repeatedly coupling two components together. According to some embodiments the kinematic mount includes a connector. The connector has a partial spherical surface and a partial cylindrical surface coupled to and substantially opposing the partial spherical surface. The connector includes a bore there-through from the partial spherical surface to the partial cylindrical surface. The bore has a first opening at the spherical surface and a second opening at the cylindrical surface, where a diameter of the first opening is different to a diameter of the second opening to account for loose tolerances of the kinematic mount, such as non coincidental geometric centers of the partial spherical surface and a partial cylindrical surface or a deviation of a threaded hole in a V-groove formed in a first plate from the center of the V-groove. In some embodiments, the diameter of the first opening is smaller than the diameter of the second opening. In some embodiments, the bore is tapered from the second opening to the first opening.

The kinematic mount may also include a first plate having a groove therein, and a second plate having a depression formed therein. At least partial spherical surface contacts the depression and the at least partial cylindrical surface contacts the groove. In some embodiments, the depression is an at least partial cone formed in the second plate, while the groove is a V-shaped groove formed in the first plate.

Also in some embodiments, the kinematic mount further includes a screw extending through the bore of the connector. The screw may be a shoulder screw having a head, an unthreaded shaft coupled to the head, and a threaded shaft coupled to the unthreaded shaft. Alternatively, the screw may include a head near the partial spherical surface and a threaded shaft extending beyond the partial cylindrical surface. The groove may include a threaded hole therein for receiving the threaded shaft of the screw therein.

The first opening may be selected based on a diameter of the unthreaded shaft and a diameter of the second opening, so as not to interfere with rotation of the connector allowed by the second opening. Alternatively, the first opening is selected based on a diameter of a screw that is inserted into the bore and a diameter of the second opening, so as not to interfere with rotation of the connector allowed by the second opening. The diameter of the second opening may be selected based on an allowed maximum deviation of the threaded hole from a center of the groove.

According to the invention there is provided another kinematic mount that includes first and second plates. The first plate has three grooves therein disposed about 120 degrees from each other. The second plate has three depressions formed therein disposed at a different apex of an equilateral triangle. Three connectors are provided, where each at least partial spherical surface contacts a respective one of the three depressions, and where each at least partial cylindrical surface contacts a respective one of the three grooves.

This kinematic mount provides increased stiffness and repeatability under high loads, while addressing any drawbacks associated with imprecise dimensions or loose tolerances.

### BRIEF DESCRIPTION OF THE DRAWINGS

For a better understanding of the nature and objects of the invention, reference should be made to the following detailed description, taken in conjunction with the accompanying drawings, in which:

FIG. 1A is a cross sectional isometric view of a kinematic mount, according to an embodiment of the invention;

FIG. 1B is a side view of the kinematic mount shown in FIG. 1, as viewed along line 1B of FIG. 1A;

FIG. 1C is a top view of the kinematic mount shown in FIGS. 1A and 1B, as viewed along line 1C of FIG. 1A;

FIG. 2A is a bottom view of a second plate shown in FIG. 1A;

FIG. 2B is a cross-sectional view of the second plate shown in FIG. 1A, as viewed along line 2B-2B′ of FIG. 2A;

FIG. 3A is a partial isometric view of a connector shown in FIG. 1A;

FIG. 3B is a top view of a connector shown in FIG. 3A, as taken along line 3B of FIG. 3A;

FIG. 3C is a first side view of a connector shown in FIG. 3A, as taken along line 3C of FIG. 3A;

FIG. 3D is a second side view of a connector shown in FIG. 3A, as taken along line 3D of FIG. 3A;

FIG. 4A is a top view of a first plate shown in FIG. 1A;

FIG. 4B is a cross-sectional view of the first plate shown in FIG. 4A, as viewed along line 4B-4B′ of FIG. 4A;

FIG. 5A is another connector, according to another embodiment of the invention;

FIG. 5B is still another connector, according to still another embodiment of the invention;

FIG. 5C is even another connector, according to even another embodiment of the invention;

FIG. 6A shows a cross-sectional side view of coincidental or colocated, where the geometric centers are not co-located;

FIG. 6B shows a cross-sectional side view of the kinematic mount of FIG. 6A when reassembled and rotated;

FIG. 6C shows a cross-sectional side view of the kinematic mount in both its original position of FIG. 6A and its rotated position of FIG. 6B;

FIG. 7A is a cross-sectional side view of another kinematic mount 700, according to another embodiment of the invention.

FIG. 7B is a cross-sectional side view of the kinematic mount of FIG. 7A with a threaded hole of a first plate not aligned with the center of the V-groove; and

FIGS. 8A and 8B are top and bottom views, respectively, of another embodiment of a connector, according to another embodiment of the invention.

Like reference numerals refer to corresponding parts throughout the several views of the drawings. For ease of reference, the first number of any reference numeral generally indicates the Figure number in which the reference numeral can be found.

### DETAILED DESCRIPTION OF EMBODIMENTS

The kinematic mount is used to removably couple two components, such as plates, together in an identical relative position as when previously coupled. The kinematic mount applies exactly six constraints against the three translational and three rotational degrees of freedom and thus reduces stress between the connector and the first plate. This increases the load capacity and the mechanical stiffness of the kinematic mount, while reducing wear and failure.

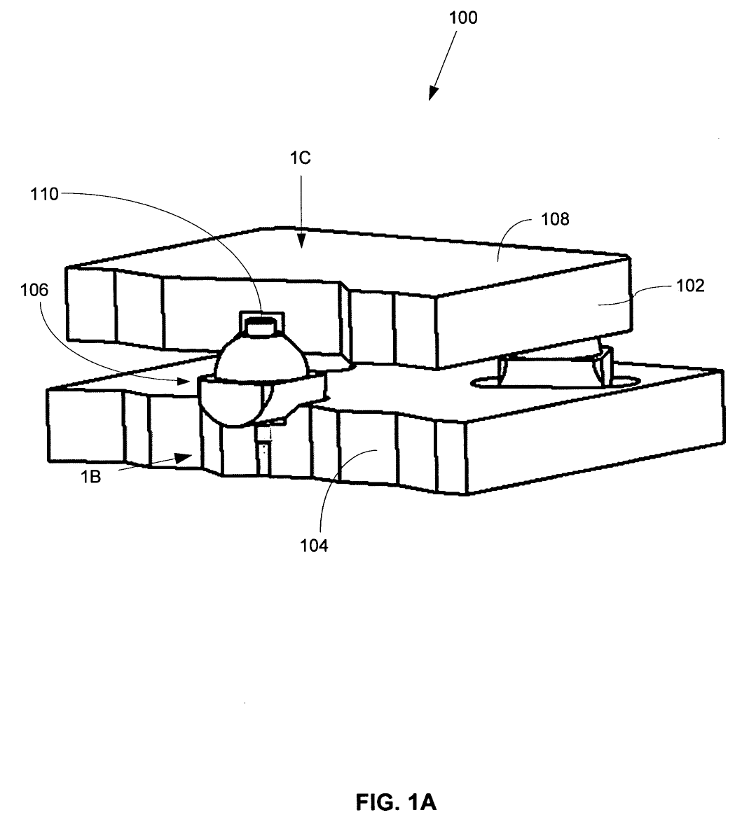

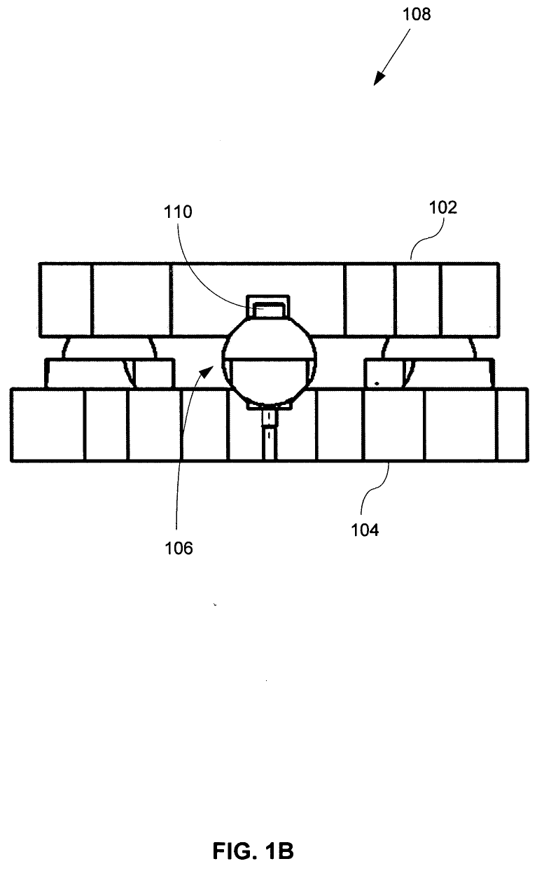

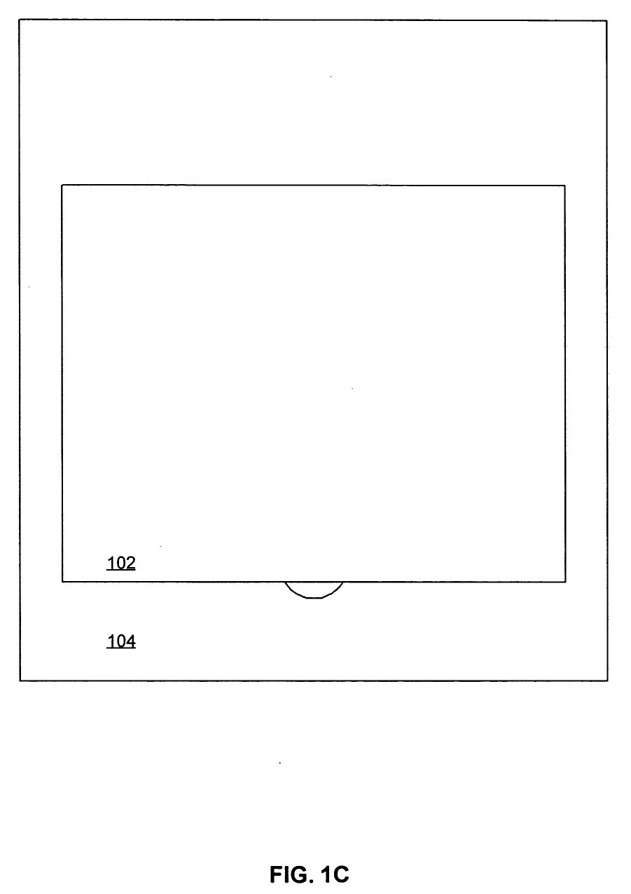

FIG. 1A is a partial isometric view of a kinematic mount 100; FIG. 1B is a side view of the kinematic mount 100, as viewed along line 1B in FIG. 1A; and FIG. 1C is a top view of the kinematic mount shown in FIG. 1A, as viewed along line 1C of FIG. 1A. When assembled, the kinematic mount includes the following components: a second plate 102, a first plate 104, and three connectors 106 used to couple the second plate, connector, and first plate to one another. For ease of explanation, the second plate 102 is partially cut-away to expose the connector 106. In a preferred embodiment the plates 102 and 104 are substantially flat, however, it should be appreciated that the plates may take on any suitable form.

In a preferred embodiment, an instrument is attached to a first side 108 of the second plate 102 remote from the connector 106. Similarly, in a preferred embodiment, the first plate 104 is attached to a rigid support, such as a tripod. Alternatively, the instrument may be attached to the first plate, and the second plate attached to a rigid support. One screw 110 is used to retain the clamp to the first plate 104, as explained in further detail below.

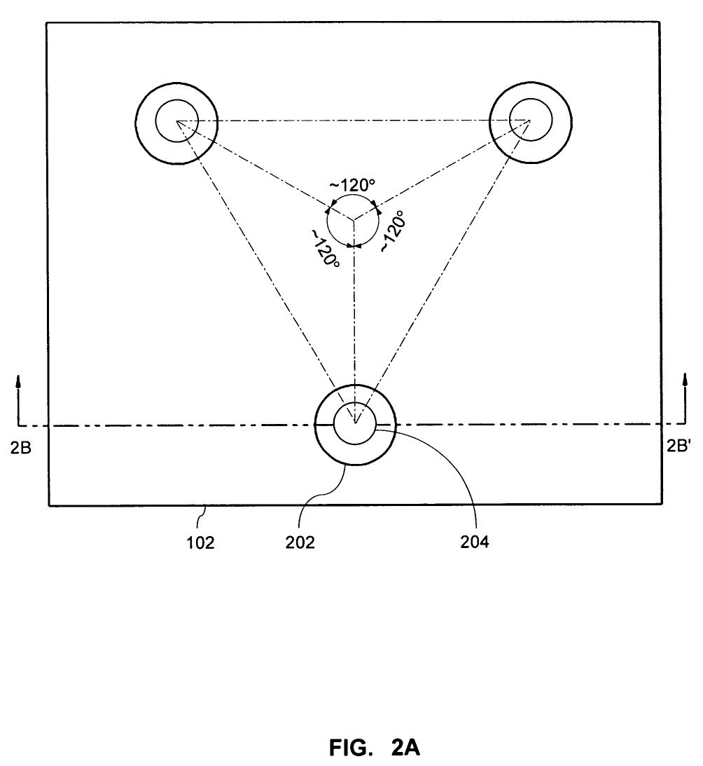

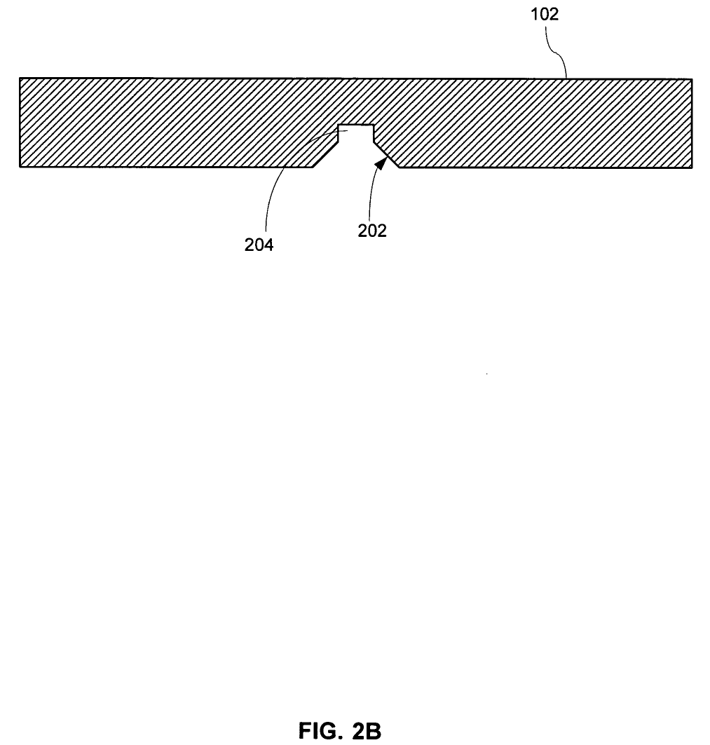

FIG. 2A is a bottom view of a second plate shown in FIG. 1A, while FIG. 2B is a cross-sectional view of the second plate shown in FIG. 1A, as viewed along line 2B-2B′ of FIG. 2A. The second plate 102 includes three indentations 202 disposed at the apexes of an equilateral triangle, i.e., disposed approximately 120 degrees apart from one another. The indentations 202 are preferably frustro-conical (conical frustum) indentations. However, in an alternative embodiment, the indentations may be any suitable shape, such as: hemispherical, frusto-hemispherical, frusto-pyramidal, pyramidal, conical, arcuate, or the like.

In a preferred embodiment, the indentation 202 includes a hole 204 at the center of the indentation 202 extending into the second plate away from the side of the second plate that has the indentation. The hole 204 is sized such that the head of the screw 110 does not interfere with the walls of the hole.

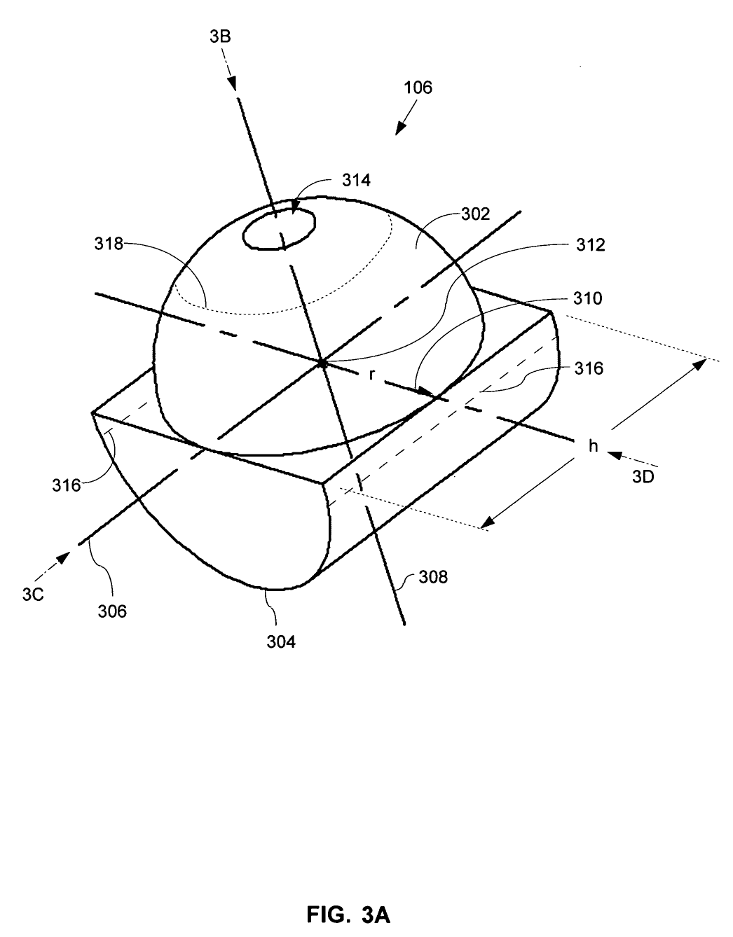

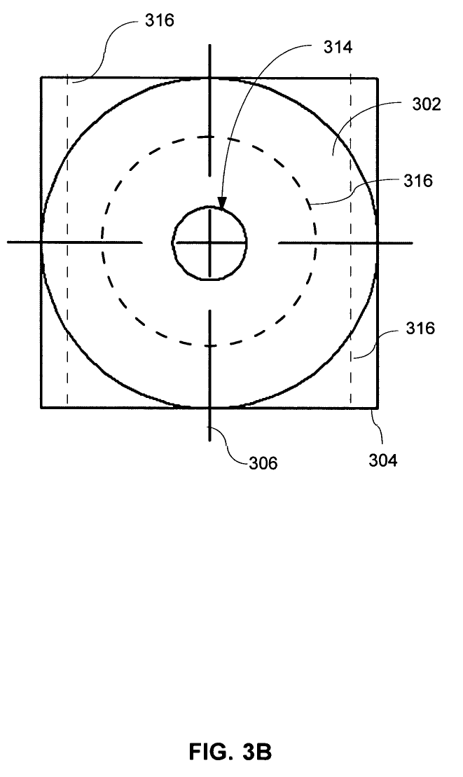

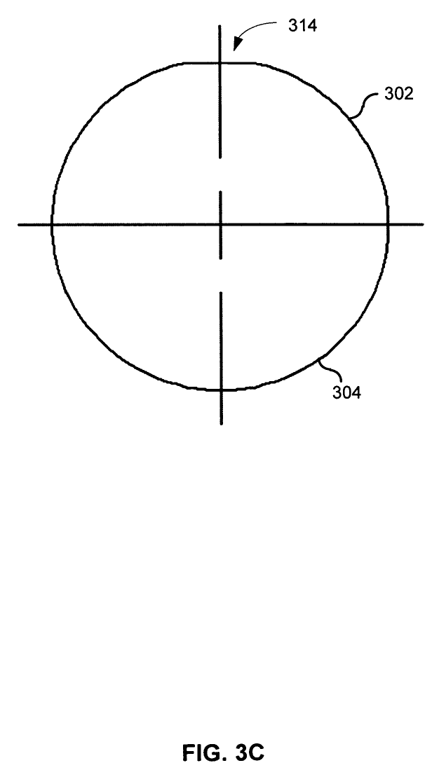

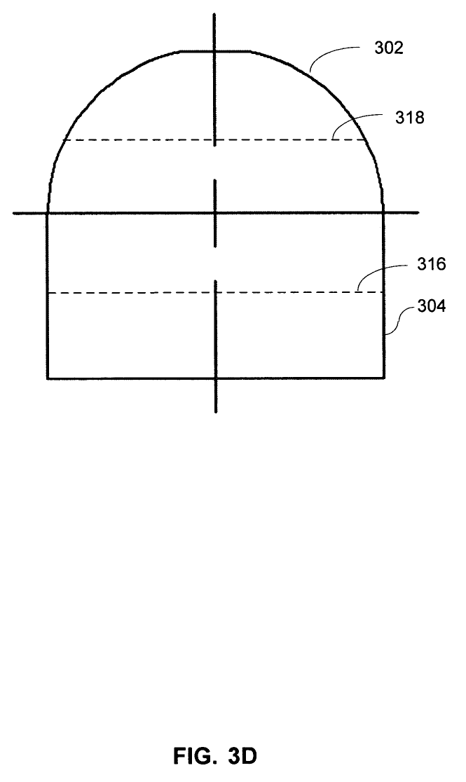

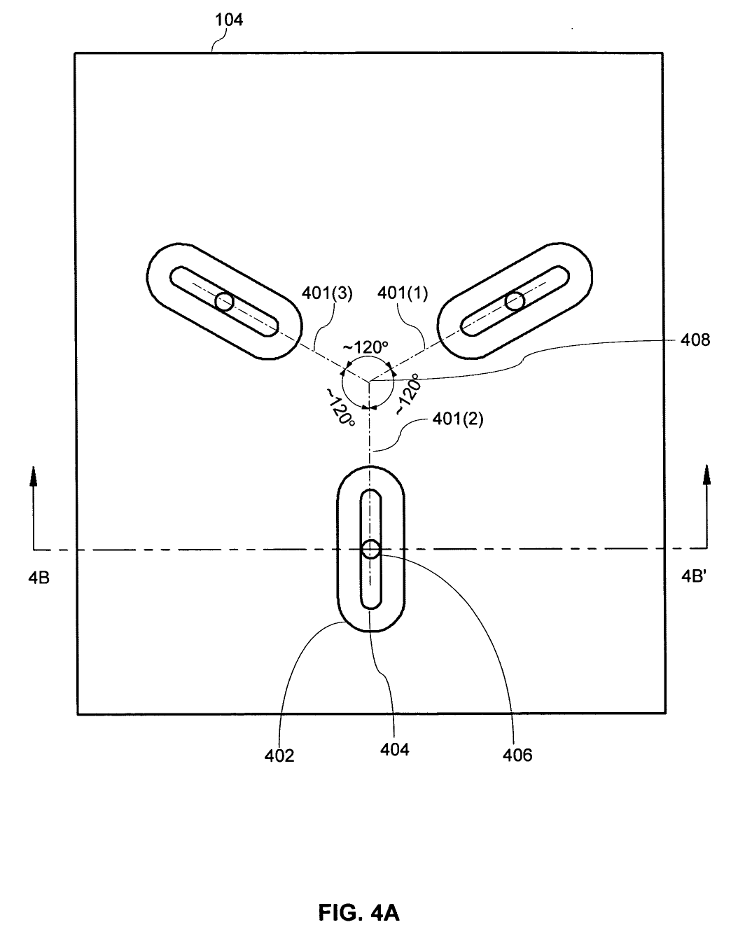

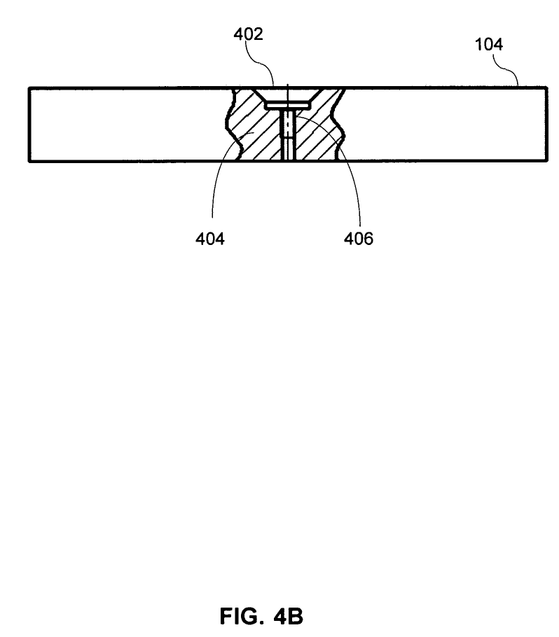

FIG. 3A is a partial isometric view of a connector 106 shown in FIG. 1A; FIG. 3B is a top view of the connector 106 shown in FIG. 3A, as taken along line 3B of FIG. 3A; FIG. 3C is a first side view of a connector shown in FIG. 3A, as taken along line 3C of FIG. 3A; and FIG. 3D is a second side view of a connector shown in FIG. 3A, as taken along line 3D of FIG. 3A. Connector 106 comprises a first surface 302 and a second surface 304. The first surface 302 defines an annular contact line 318 between the connector 106 and second plate 102 (FIG. 1A)—within the indentation 202 (FIGS. 2A and 2B) of the second plate 102. Similarly, the second surface 304 defines two contact lines 316 between the connector 106 and the first plate 104 (FIG. 2A)—within a groove 402 (FIG. 4A). The contact lines 316 are substantially parallel to one another.

In a preferred embodiment, the first surface 302 defines a hemisphere and the second surface 304 defines a half-cylinder or hemicylinder. The hemisphere is half of a sphere cut by a plane passing through the sphere's center 312. Similarly, the half-cylinder is half a cylinder cut by the same plane passing through the cylinders longitudinal axis 306. Therefore, the centers of the hemisphere and cylinder preferably coincide so that the plates will not move relative to each other on consecutive reassemblies.

Also in a preferred embodiment, the radius “r” 310 of the hemisphere about the center 312 is substantially the same as the radius “r” of half-cylinder about the longitudinal axis 306.

Still further, in a preferred embodiment, the connector 106 forms a hole 314 there through that intersects: an apex of the first surface 302, the center 312, and an apex of the second surface 304. The hole has a diameter larger than the diameter of the screw 110 (FIG. 1A) passing through it, letting the connector and first plate adjust themselves without being over constrained by the screw location. This allows any clamping force between the second plate, connector, and first plate to be evenly distributed about the annular contact line 318 and the two substantially parallel contact lines 316.

The location of each plate is tied to the location of the connector through the center of the spherical surface and the centerline of the cylindrical surface. Because the connector is free to rotate a little about the centerline of the cylindrical surface, if the center of the spherical surface and the centerline of the cylindrical surface do not coincide, the plates will move relative to each other on consecutive reassembly. Accordingly, the centers of the spherical surface and the centerline of the cylindrical surface preferably coincide.

FIG. 4A is a top view of a first plate 104 shown in FIG. 1A, while FIG. 4B is a cross-sectional view of the first plate 104 shown in FIG. 4A, as viewed along line 4B-4B′ of FIG. 4A. The first plate 104 includes three grooves 402 extending along longitudinal axes 401(1)-(3) toward a central point 408. The longitudinal axes of the grooves are disposed 120 degrees apart from one another. Each groove 402 preferably forms a frusto-triangular prism indentation in the first plate, i.e., an indentation having a frusto-triangular cross-section. However, in an alternative embodiment, the grooves may have any suitable shape or cross section, such as: a triangular cross-section; a V-shaped cross-section; a half-cylinder indentation; an arcuate cross-section; or the like.

In a preferred embodiment, the first plate 104 defines a flat portion 404 at the apex (or low-point depending on orientation) of the groove 402. The flat portion 404 includes a threaded hole 406 at its center extending through the first plate. The hole 406 preferably has a diameter slightly larger than the screw 110 (FIG. 1A).

Therefore, to assemble the kinematic mount, a connector 106 (FIG. 1A) is placed in each groove 402 (FIG. 4A) of the first plate 104 (FIG. 1A) so that the second surface 304 (FIG. 3A) of each connector forms two substantially parallel contact lines 316 (FIGS. 3A and 3B) with each corresponding groove. The indentations 202 (FIG. 2A) formed in the second plate 102 (FIG. 1A) are then positioned over the corresponding first surface 302 of each connector 106 (FIG. 1A) so that the first surface 302 (FIG. 3A) of each connector forms an annular contact line 318 (FIGS. 3A and 3B) with each corresponding indentation. The two plates are now aligned.

In a preferred embodiment, a screw 110 (FIG. 1A) is passed through the hole 406 (FIG. 4A) in the first plate 104 (FIG. 1A), through the hole 314 (FIG. 3B) in the connector 106 (FIG. 1A), and into the threaded hole 204 (FIG. 2B) in the second plate 102 (FIG. 1A). The screw is then tightened to clamp the first and second plates together.

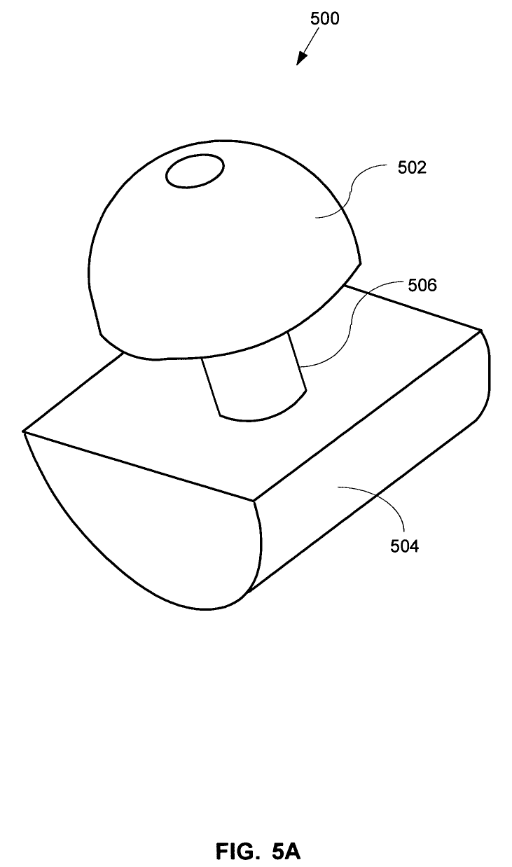

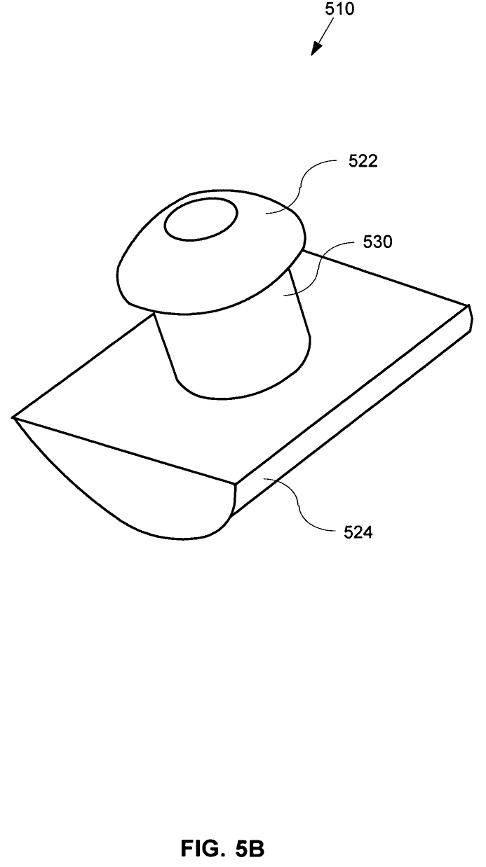

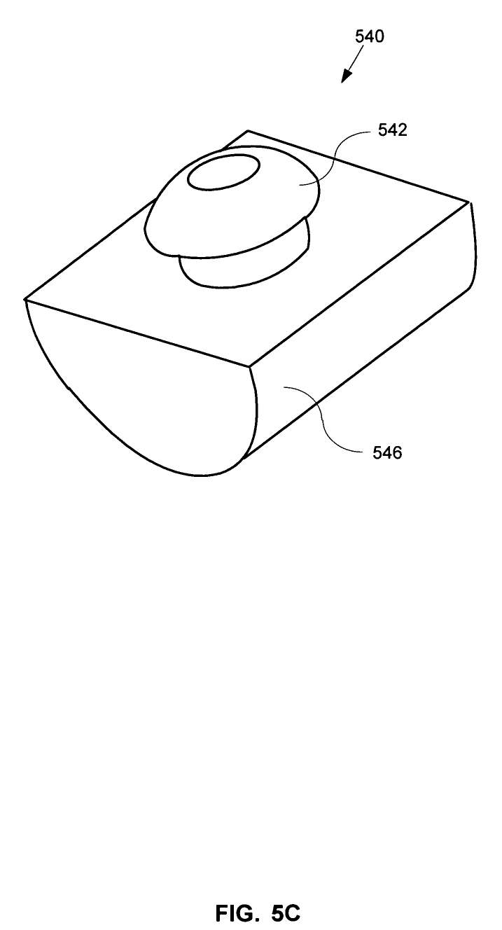

FIG. 5A is another connector 500, according to another embodiment of the invention. This connector 500 has a partial spherical first surface 502 coupled to a half-cylinder second surface 504 by means of a post. The first surface 502 still defines an annular contact line and the second surface 504 still defines two contact lines, as described above.

FIG. 5B is still another connector 510, according to still another embodiment of the invention. Here, a partial spherical first surface 522 is coupled to a partial cylindrical second surface 524 via a post 530.

FIG. 5C is even another connector 540, according to even another embodiment of the invention. Here a partial spherical first surface 542 is coupled to a cylindrical second surface 546, also via a post.

The above described substantially parallel contact lines form line contacts with the sides of the grooves 402 (FIG. 4A). This is quite unlike the prior art, which forms a point contact at the grooves. It is this line contact that distributes the applied load, and reduces the build-up of point stresses that form at point contacts. Therefore, the above described embodiments increases stability, stiffness and, therefore, repeatability under higher loads of the kinematic mount, while reducing stress and wear.

One drawback of the above described embodiments is that they require the connectors to have very precise dimensions or tight tolerances. For example, it is desirable that the geometric center of the spherical surface either coincides or is aligned with a geometric center of the cylindrical surface, so that when the plates are loaded, the connector does not rotate. This lack of rotation of the connector allows the kinematic mount to be disassembled and later reassembled, with any of the connectors in any groove and cone, with the plates returning to the identical position that they were in before they were disassembled. However, kinematic mounts with very precise dimensions, such as connectors with coincident or aligned geometric centers, are extremely difficult and costly to manufacture. Accordingly, a connector that does not require precise dimensions, or that will tolerate loose dimensions, but that will nevertheless ensure precise and accurate realignment is described below.

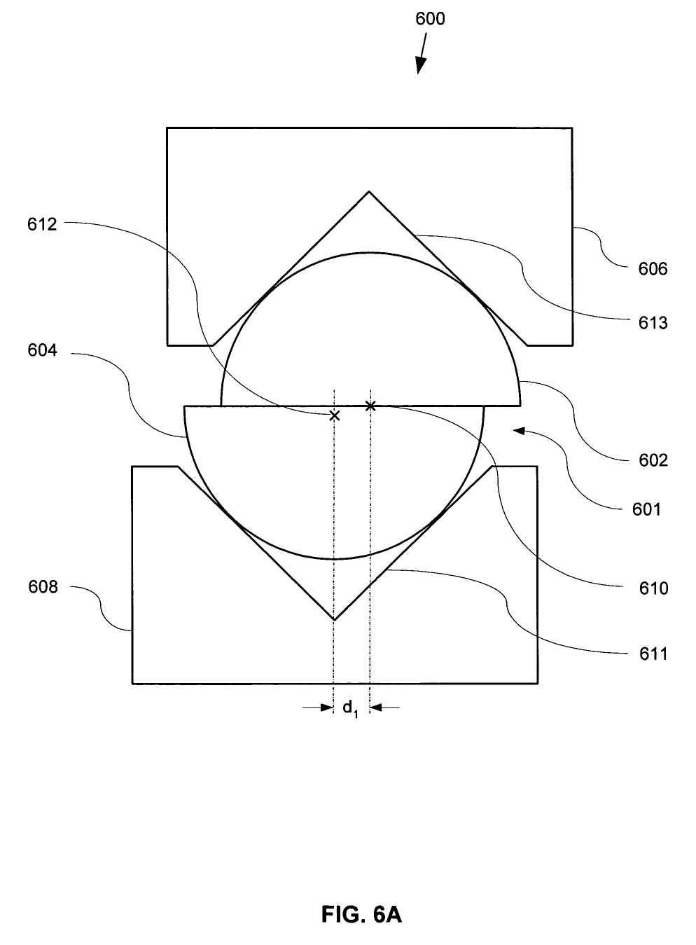

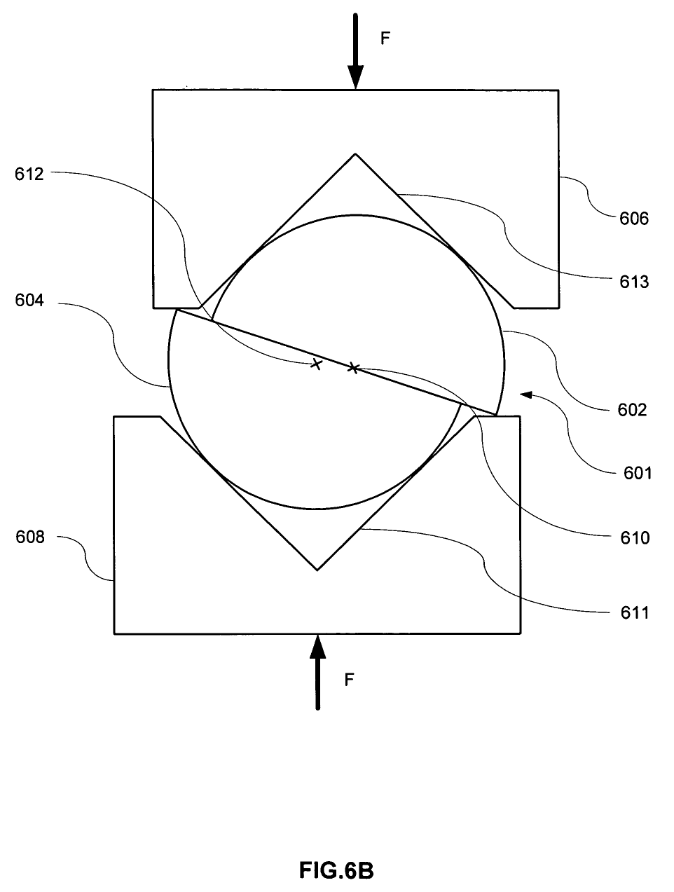

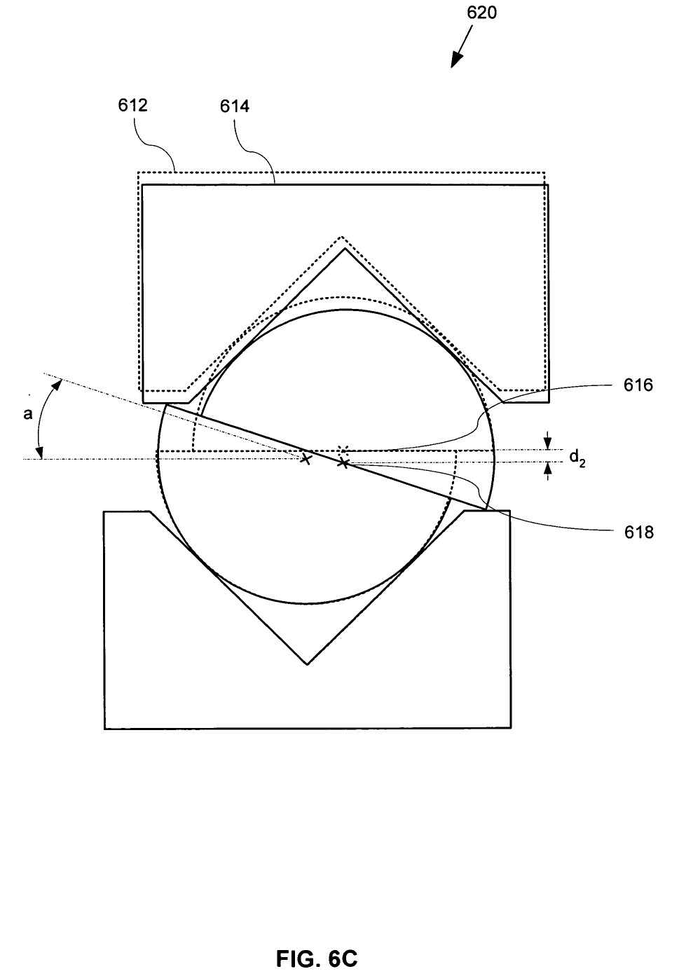

FIG. 6A shows a cross-sectional side view (without cross-hatching) of another kinematic mount 600, according to another embodiment of the invention. This figure shows an exaggerated deviation in centers of rotation to aid the explanation of the embodiment. The kinematic mount includes a hemispherical surface 602 that is positioned in a cone 613 formed in a second plate 606, and a cylindrical surface 604 positioned in a V-groove 611 formed in a first plate 608. As it is typically not feasible to manufacture the connector with perfectly aligned or coincidental geometric centers, the geometric center 610 of the hemispherical surface 602 and the geometric center 612 of the cylindrical surface 604 may be offset from one another by a distance “d.”

FIG. 6B shows a cross-sectional side view (without cross-hatching) of the kinematic mount 600 of FIG. 6A when loaded with forces “F”. Because the geometric centers 610 and 612 are offset from one another, the connector 601 rotates in the cone 613 and the V-groove 611. In this embodiment, the first plate 608 is fixed in space, but the second plate 606 is free to move. As the first plate is fixed in space, the center of the V-groove 611 in the first plate 608 is also fixed in space. As the geometric center 610 of the hemispherical surface 602 is offset from the geometric center 612 of the cylindrical surface 604, a moment is created by the forces “F” which causes the connector to rotate. The cylindrical surface 604 rotates in the fixed V-groove 611 about its geometric center 612, while the hemispherical surface 602 rotates in the cone 613 of the second plate second plate 606. The geometric centers of the cylindrical surface 604 and hemispherical surface 602 will always remain aligned with the centers of the V-groove and cone, respectively. Accordingly, as the first plate is fixed in space and can't move, the second plate moves to ensure that the geometric center of the hemispherical surface remains aligned with the center of the cone 613. In other words, the second plate 606 moves both right and down, as shown in FIG. 6B.

FIG. 6C shows a cross-sectional side view (without cross-hatching) of the kinematic mount in both its original position of FIG. 6A (broken line) and its rotated position of FIG. 6B (solid line). As can be seen from this figure, the connector rotates through an angle “a,” and the geometric center of the hemispherical surface 602 moves from a position 616 to a position 618, i.e., moves a distance “d₂.” The second plate also moves from a position 612 to a position 614.

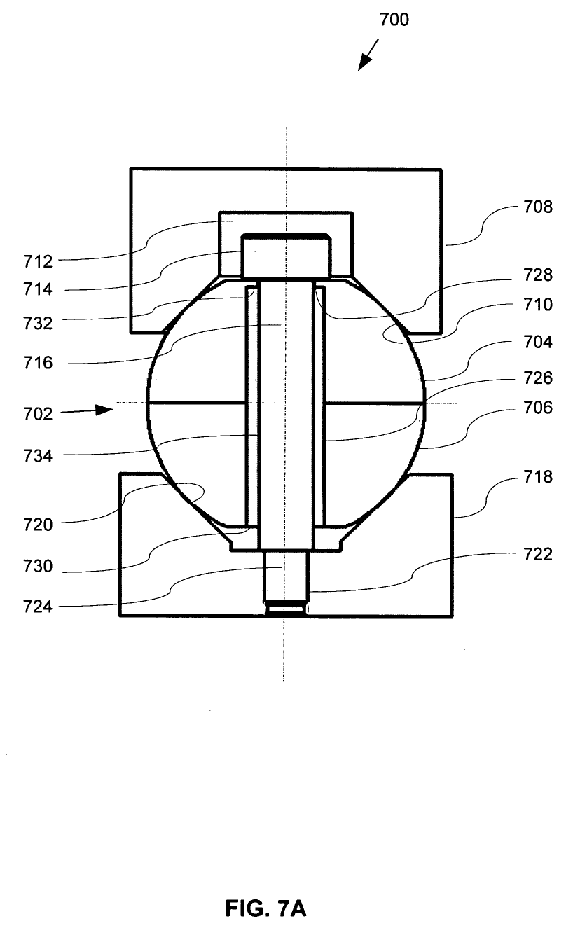

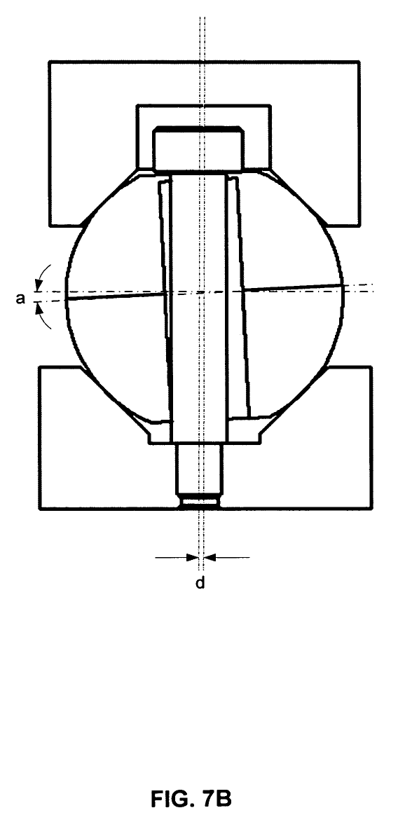

As each connector may have the geometric centers of the hemispherical surface and the cylindrical surface in slightly different positions, if the kinematic mount is disassembled and reassembled with the connectors in different locations (i.e., the hemispherical surface and/or the cylindrical surface located in different V-grooves and/or cones), or with a cylindrical surface of a connector rotated in the V-groove (i.e., the connector rotated such that the longitudinal axis of the cylindrical surface is flipped 180 degrees), then the first and first plates may not realign into their original positions. This may defeat one of the primary functions of the kinematic mount, namely to ensure the identical realignment of the plates on subsequent assemblies. To address this drawback, a different embodiment of the kinematic mount has been developed, as described below in relation to FIGS. 7A and 7B.

FIG. 7A is a cross-sectional side view (without cross-hatching) of another kinematic mount 700, according to another embodiment of the invention. FIG. 7B is a cross-sectional side view (without cross-hatching) of the kinematic mount 700 of FIG. 7A with a threaded hole of a first plate not aligned with the center of the V-groove. The kinematic mount 700 addresses the drawbacks associated with imprecise dimensions or loose tolerances. By retaining the connector to one of the plates, such as by retaining the connector to the plate with a screw, the other of the plates may be disassembled from the connector and attached plate combination, and later reassembled into its identical prior position before disassembly.

The kinematic mount 700 includes a connector 702 having an at least partial spherical surface 704 coupled to an at least partial cylindrical surface 706. In these embodiments the at least partial spherical surface 704 is a hemispherical surface or truncated hemispherical (frusto-hemispherical) surface, and the at least partial cylindrical surface 706 is a half-cylindrical surface or truncated half-cylinder (frusto-half-cylindrical) surface.

In a similar manner to that described above, a second plate 708 is configured to receive the at least partial spherical surface 704 in an at least a partial cone shaped (or frusto-conical) depression 710 formed in the second plate 708. The apex of the at least partial cone shaped depression 710 includes a cutout 712 to ensure that the second plate 708 does not interfere with or touch the head 714 of a screw 716 (described below). Also, as described above, a first plate 718 is configured to receive the at least partial cylindrical surface 706 in an at least partial “V” shaped depression or V-groove 720 formed in the first plate 718. In some embodiments, the apex of the V-groove 720 that does not make contact with the at least partial cylindrical surface 706 may be truncated or flat (frusto-triangular-prism), as shown. Also in some embodiments, a threaded hole 722 is formed in the first plate 718 at or near the apex of the V-groove 720. The threaded hole 722 is configured and dimensioned for receiving a threaded shaft 724 of the screw 716 therein. However, due to imprecise dimensions or loose tolerances, it is difficult to perfectly form the threaded hole 722 at the center or apex of the V-groove 720. Any deviation of the threaded hole from the center of the V-groove 720 will cause the connector to rotate, which may potentially affect subsequent reassemblies of the kinematic mount, in a similar manner to that described above in relation to FIGS. 6A-6C.

To address the imprecise dimensions or loose tolerances discussed above in relation to FIGS. 6A, 6B, 7A and 7B, the connector 702 is attached to one of the plates 708 or 718, such as by using a screw 716. By attached it is meant that the connector is retained in contact with the plate, but may still be able to rotate through limited angles. In some embodiments, the screw 716 includes a head 714, which is coupled to an unthreaded shaft 734, which is coupled to a threaded shaft 724. This type of screw is know as a shoulder screw.

The screw 716 passes through a bore 726 in the connector 702. The bore 726 extends through the connector from the at least partial spherical surface 704 to the at least partial cylindrical surface 706. In some embodiments the bore extends substantially perpendicular to a longitudinal axis that runs through the center of a cylinder that defines the at least partial cylindrical surface. The bore 726 has a first opening 728 at the at least partial spherical surface 704, and a second opening 728 at the at least partial cylindrical surface 706. Also in some embodiments, the diameter of the first opening 728 is smaller than the diameter of the second opening 730. The smaller first opening 728 may be formed by a shoulder 732 that extends to close the diameter of the bore. In an alternative embodiment, the bore 726 may be tapered from the second opening 730 to the first opening 728.

The diameter of the second opening 730 is selected based on the allowed maximum deviation of the location of the threaded hole 722 from the center of the V-groove, i.e., “d” of FIG. 7B. The diameter of the first opening 728 is selected based on the allowed maximum angle that the connector can rotate (“a” of FIG. 7B) and the diameter of the unthreaded shaft 734.

For example, the maximum angle of rotation of the connector can be represented by:
a=(d₂−d₀)/(2D′)

where “a” is the maximum angle of rotation of the connector; “d₂” is the diameter at the second opening 730; “d₀” is the diameter of the unthreaded shaft 734; and “D′” is the longitudinal length of the unthreaded shaft 734. The maximum angle of rotation of the connector can also be represented by:
a=2e/D′

where “e” is the deviation of the threaded hole 722 from the center of the V-groove 720. The maximum angle of rotation of the connector can also be represented by:
a=(d₁−d₀)/t

where “d₁” is the diameter at the first opening 728; and “t” is the thickness of the shoulder 732.

Based on the above:
d₂−d₀=4e

Accordingly, for: a connector with a diameter of 25 mm, and with the length of the unthreaded shaft being approximately equal to the diameter of the connector (D′=25 mm); a diameter of the unthreaded shaft is 5 mm (d₀=5 mm); and a thickness of the shoulder is 1 mm (t=1 mm), then the diameter of the second opening can be calculated to be 7 mm (d₂₌₇ mm), and the diameter of the first opening can be calculated to be 5.04 mm (d₁=5.04 mm).

When first assembled, the at least partial cylindrical surface 706 of the connector 702 is placed into the V-groove 720. The shoulder screw 716 is then inserted through the bore 726. The threaded shaft 724 is threaded into the threaded hole 722 and the screw tightened. If the position of the threaded hole 722 deviates from the center of the V-groove 720, as shown by distance “d” in FIG. 7B, then the connector 702 will rotate through an angle, as shown by “a” in FIG. 7B. Both the diameter of the second opening 730 and the gap between the shaft 734 and the first opening 728 govern the maximum angle through which the connector can rotate. Once the screw 716 has attached the connector to the first plate 718, the second plate 708 can be repeatedly disassembled and reassembled into an identical position with respect to the combination of the three connectors and the first plate.

In an alternative embodiment, a threaded hole may be formed in the second plate instead of the first plate. In this embodiment, the screw couples the connector to the second plate, and the first plate may be disassembled and reassembled. It should also be noted that although only one connector is shown and described in relation to FIGS. 6A-7B, the kinematic mount includes three similar connectors and corresponding depressions and grooves in the first and first plates.

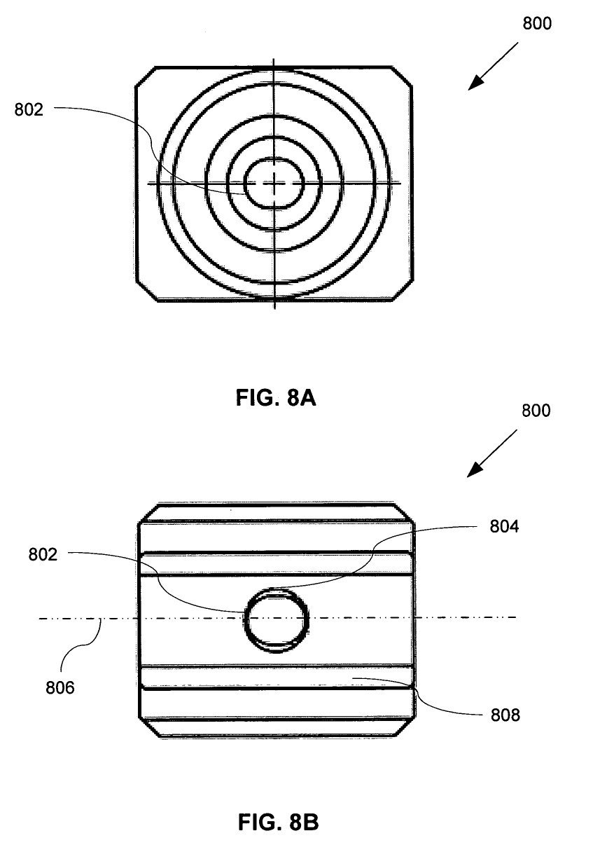

FIGS. 8A and 8B are top and bottom views, respectively, of another embodiment of a connector 800. In this embodiment, the first opening 802 has a oval shape instead of the circular shape of the second opening 804. The oval shape of the first opening 802 has a short diameter smaller than the diameter of the second opening 804 and a large diameter that is substantially the same size as the second opening 804. The oval shape of the first opening 802 restricts the rotation of the connector at the first opening in a direction perpendicular to the longitudinal axis 806 of the connector, but allows the connector to move more at the first opening along the longitudinal axis. This is because it is desirable that the connector locates its equilibrium in the V-groove, which may require the at least partial cylindrical surface to translate along the V-groove.

The foregoing descriptions of specific embodiments of the present invention are presented for purposes of illustration and description. They are not intended to be exhaustive or to limit the invention to the precise forms disclosed. Obviously many modifications and variations are possible in view of the above teachings. For example, the first surface and second surface may take on any suitable shape, as long as each surface defines the contact lines, as described above. Also, the various components described above are preferably made of a hard material, such as stainless steel. Alternatively, any suitable material may be used. The embodiments were chosen and described above in order to best explain the principles of the invention and its practical applications, to thereby enable others skilled in the art to best utilize the invention and various embodiments with various modifications as are suited to the particular use contemplated. Furthermore, the order of steps in the method are not necessarily intended to occur in the sequence laid out. It is intended that the scope of the invention be defined by the following claims and their equivalents. In addition, any references cited above are incorporated herein by reference.

What is claimed is:

1. A kinematic mount comprising:
a connector having:
a partial spherical surface; and
a partial cylindrical surface coupled to and substantially opposing said partial spherical surface, wherein said connector includes a bore there-through from said partial spherical surface to said partial cylindrical surface, where said bore has a first opening at said spherical surface and a second opening at said cylindrical surface, where a diameter of said first opening is different to a diameter of said second opening to account for loose tolerances of the kinematic mount.

2. The kinematic mount of claim 1, wherein a diameter of said first opening is smaller than a diameter of said second opening.

3. The kinematic mount of claim 2, further comprising:
a first plate having a groove formed therein; and
a second plate having a depression formed therein, wherein said at least partial spherical surface contacts said depression and said at least partial cylindrical surface contacts said groove.

4. The kinematic mount of claim 3, wherein said depression is an at least partial cone formed in said second plate, and said groove is a V-shaped groove formed in said first plate.

5. The kinematic mount of claim 3, further comprising a screw extending through said bore of said connector.

6. The kinematic mount of claim 5, wherein said screw is a shoulder screw having a head, a unthreaded shaft coupled to said head, and a threaded shaft coupled to said unthreaded shaft.

7. The kinematic mount of claim 5, wherein said first opening is selected based on a diameter of said unthreaded shaft and a diameter of said second opening, so as not to interfere with rotation of the connector allowed by said second opening.

8. The kinematic mount of claim 5, wherein said screw comprises a head near said partial spherical surface and a threaded shaft extending beyond said partial cylindrical surface.

9. The kinematic mount of claim 8, wherein said groove includes a threaded hole therein for receiving said threaded shaft of said screw therein.

10. The kinematic mount of claim 9, wherein a diameter of said second opening is selected based on an allowed maximum deviation of said threaded hole from a center of said groove.

11. The kinematic mount of claim 2, wherein said first opening is selected based on a diameter of a screw that is inserted into said bore and a diameter of said second opening, so as not to interfere with rotation of the connector allowed by said second opening.

12. The kinematic mount of claim 2, wherein said at least partial spherical surface forms a shoulder extending towards a longitudinal axis of said bore.

13. The kinematic mount of claim 2, wherein said bore is tapered from said second opening to said first opening.

14. The kinematic mount of claim 2, wherein the second opening is equal to four times a deviation of a threaded hole from a center of a V-groove, plus the diameter of a unthreaded shaft of a screw.

15. The kinematic mount of claim 2, further comprising:
a first plate having three grooves therein, where each groove is disposed about 120 degrees from each other groove;
a second plate having three depressions formed therein, where each depression is disposed at a different apex of an equilateral triangle; and
three of said connectors, where each at least partial spherical surface contacts a respective one of said three depressions, and where each at least partial cylindrical surface contacts a respective one of said three grooves.

16. The kinematic mount of claim 15, wherein each depression is an at least partial cone formed in said second plate, and each groove is a V-shaped groove formed in said first plate.

17. The kinematic mount of claim 2, wherein said first opening has an oval shape with a short diameter and a long diameter, where said long diameter is substantially parallel with a longitudinal axis of said connector.

18. The kinematic mount of claim 1, wherein a diameter of said second opening is smaller than a diameter of said first opening, and a screw extends through said bore for coupling said connector to said second plate.

19. A kinematic mount comprising:
a connector having:
a first surface configured to contact a second plate along an annular contact line; and
a second surface coupled to said first surface, wherein said second surface configured to contact a first plate along substantially two parallel lines,
wherein said connector includes a bore there through from said first surface to said second surface, where said bore has a first opening at said first surface and a second opening at said second surface, where said first opening is smaller than said second opening.

20. A kinematic mount comprising:
a second plate having three indentations therein, where said indentations are each located at respective apexes of an equilateral triangle;
a first plate having three grooves therein, where said grooves are spaced 120 degrees apart from one another; and
three connectors, each comprising:
a first surface configured to contact a second plate along an annular contact line; and
a second surface coupled to said first surface, wherein said second surface configured to contact a first plate along substantially two parallel lines, wherein said connector includes a bore there through from said first surface to said second surface, where said bore has a first opening at said first surface and a second opening at said second surface, where said first opening is smaller than said second opening.
